(19) United States
(12) Patent Application Publication
(10) Pub. No.: US 2007/0209049 A1
(43) Pub. Date: Sep. 6, 2007

(54) Method of Searching for Programme Content

(75) Inventors: Declan Patrick Kelly, Shanghai (CN); Philip Steven Newton, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., Eindhoven (NL)

(21) Appl. No.: 10/596,770

(22) PCT Filed: Dec. 21, 2004
(86) PCT No.: PCT/IB04/52874

§ 371 Date: Apr. 12, 2007

(30) Foreign Application Priority Data
Jan. 9, 2004 (EP) 04100043.1

(51) Int. Cl. H04N 7/16

(52) U.S. Cl. 725/53

(57) ABSTRACT

There is provided a communication network (10) operable to search for programme content. The network (10) is distinguished in that it comprises: (a) a plurality of mutually interconnected network nodes (100, 110) susceptible to storing programme data content and at least one of electronic programme guides (EPG) and associated meta-data thereat; (b) at least one user-operable node (20) coupled to the network (10), the at least one user-operable node (20) including user-interfacing means (30, 50) for receiving instructions from a user (60) and presenting results to the user (60). The network (10) is arranged such that: (c) the plurality of network nodes (100) and/or the at least one user-operable node (20) are operable to access electronic programme guide (EPG) data and/or associated metadata providing a record of at least previous programme data content communicated within the network (10); (d) the network (10) is operable to present one or more electronic programme guides (EPG) to the user (60) for generating therefrom a search request susceptible to utilizing meta-data associated with the one or more electronic programme guides (EPG) for use in identifying corresponding data content available in the network (10); and (e) the at least one user-operable node (20) is operable to receive data content thereat corresponding to the search request.

The present invention relates to methods of searching for programme content; in particular, but not exclusively, the invention relates to searching for programme content with regard to Electronic Programme Guide (EPG) data recording Content Reference Identifiers (CRID), especially in the context of peer-to-peer networks. Moreover, the invention also relates to apparatus implementing the method.

Contemporary television viewers are being confronted with a constantly increasing number of programme options as a consequence of television programming now becoming available from major networks, cable channels, satellite channels, pay-by-view, community access television and so on. In parallel with such a growth of television programming is a decrease in an amount of leisure time viewers have for television watching purposes. Similar considerations apply to other types of content, for example music data content available form various server sources on the Internet.

In consequence, it has been appreciated that more efficient methods of searching for programme content are desirable. For example, in a published international PCT patent application no. WO 01/47238 (PCT/US00/35152), there is described a method and apparatus for searching a database of programme information in an interactive, network-based video recording system for purposes of identifying programmes of interest. When using the apparatus, a user enters search terms using a virtual alphanumeric keyboard displayed in a viewer interface by means of a remote control; for example, the user interface is beneficially a television monitor and remote control is an existing remote control for the user to operate the television monitor whilst spatially remote therefrom. The user is able to search according to programme title, indexed attributes such as category, actor and director; alternatively, searching by key word also enables the user to search by programme content or subject matter. Thus, the PCT patent application discloses an interactive network-based video recording system.

The inventors have appreciated that one typical way that users identify content of interest is by recommendations from friends and associates; however, such recommendations are often not precise. Frequently, such recommendations will be based on date and time, and broadcast channel together with some indication of corresponding subject matter. Moreover, the recommendation will usually not include Content Reference Identifiers (CRID) or even in most cases an exact name of a series and associated episode name and/or number. Therefore, it is potentially difficult for the user to find content in a peer-to-peer network based on a recommendation. The inventors have therefore devised a solution which, at least in part, is susceptible to addressing programme searching problems experienced by such users.

A first object of the present invention is to provide an easier and more natural method of locating programme data content in a peer-to-peer network.

A second object of the present invention is to a method of identifying programme data content in a peer-to-peer network and conveying the content to one or more apparatus coupled to the network.

A third object of the invention is to provide apparatus capable of interfacing with a peer-to-peer network to identify programme data content therein.

According to a first aspect of the present invention, there is provided a method of searching for programme content, characterized in that the method comprises the steps of:
(a) providing a communication network comprising a plurality of mutually interconnected network nodes susceptible to storing programme data content and at least one of electronic programme guides (EPG) and associated meta-data thereat;
(b) providing at least one user-operable node coupled to the network, the at least one user-operable node including user-interfacing means for receiving instructions from a user and presenting results to the user;
(c) arranging for the plurality of network nodes and/or the at least one user-operable node to access electronic programme guide (EPG) data and/or associated meta-data providing a record of at least previous programme data content communicated within the network;
(d) presenting one or more electronic programme guides (EPG) to the user for generating therefrom a search request susceptible to utilizing meta-data associated with the one or more electronic programme guides (EPG) for use in identifying corresponding data content available in the network; and
(e) receiving at the at least one user-operable node data content corresponding to the search request.

The invention is of advantage in that it is capable of providing for more efficient and rapid searching and identification of programme data content.

Meta-data is to be construed to mean intermediate searching results and/or intermediate details on data content storage location generated in connection with electronic programme guides (EPG's).

Preferably, in the method, the network is arranged to have stored therein electronic programme guide data (EPG) and/or associated meta-data corresponding to previously communicated programme data content as well as present and future programme data content to be communicated through the network. By storing electronic programme guide (EPG) data and associated meta-data in the network rather than merely discarding it, a benefit arises in that associated programme data content remains still accessible to the benefit of the user.

Preferably, in the method, the electronic programme guides (EPG) and/or their associated meta-data include data pertaining to past programme data content together with location data indicative of whether the programme data content is available locally in the at least one user-operable node or in the plurality of nodes of the network. Local storage of electronic programme guides (EPG) and associated meta-data is of advantage in that corresponding programme data content can potentially be accessed more rapidly without needing to search the entire network.

Preferably, in the method, the electronic programme data (EPG) relating to previously communicated programme data content within the network searched in response to the search request corresponds to programme data content communicated not more than a predetermined period prior to issuance of the search request from the at least one user-operable node. More preferably, the predetermined period is substantially 1 month. Deletion of electronic programme guides (EPG) and associated meta-data after the predetermined period is of advantage in that overload of memory storage capacity in the network, for example in its hard disc drives, can potentially be avoided. A predetermined period of 1 month is found in practice to be an especially preferred compromise.

Preferably, in the method, the network is arranged to include at least one data server for providing data relating to electronic programme guides and/or programme data content. The data server is of benefit in that it is susceptible to providing a concentrated and rapidly accessible repository for data within the network.

Preferably, in the method, at least a subset of the electronic programme guide (EPG) data and programme data content are stored in mutually different parts of the network. By separate storage of electronic programme guides (EPG) and their associated meta-data, it is feasible to utilized memory storage capacity available within the network more efficiently.

Preferably, in the method, the network nodes are configured in a manner of a peer-to-peer network. A peer-to-peer network is of advantage in that it is potentially robust and is operable to cater well to data queries issued from its nodes.

Preferably, in the method, at least one of the network nodes and the at least one user-operable node each include a non-volatile memory, more preferably a hard disc drive, for storing programme data content and/or electronic programme guide (EPG) data therein. The use of hard disc drives is especially pertinent in that such drives are susceptible to providing a compromise of suitable fast response, relatively low cost and sufficient memory capacity.

According to a second aspect of the present invention, there is provided a communication network operable to search for programme content, characterized in that the network comprises:
(a) a plurality of mutually interconnected network nodes susceptible to storing programme data content and at least one of electronic programme guides (EPG) and associated meta-data thereat;
(b) at least one user-operable node coupled to the network, the at least one user-operable node including user-interfacing means for receiving instructions from a user and presenting results to the user,

the network being arranged such that:
(c) the plurality of network nodes and/or the at least one user-operable node are operable to access electronic programme guide (EPG) data and/or associated meta-data providing a record of at least previous programme data content communicated within the network;
(d) the network is operable to present one or more electronic programme guides (EPG) to the user for generating therefrom a search request susceptible to utilizing meta-data associated with the one or more electronic programme guides (EPG) for use in identifying corresponding data content available in the network; and
(e) the at least one user-operable node is operable to receive data content thereat corresponding to the search request.

Preferably, the network is arranged to have stored therein electronic programme data (EPG) corresponding to previously communicated programme data content as well as present and future programme data content to be communicated through the network.

Preferably, in the network, the electronic programme guides (EPG) and/or their associated meta-data include data pertaining to past programme data content together with location data indicative of whether the programme data content is available locally in the at least one user-operable node or in the plurality of nodes of the network.

Preferably, in the network, the electronic programme data (EPG) relating to previously communicated programme data content within the network searched in response to the search request corresponds to programme data content communicated not more than a predetermined period, for preferably not more than 1 month, prior to issuance of the search request from the at least one user-operable node.

Preferably, the network is arranged to include at least one data server for providing data relating to electronic programme guides and/or programme data content.

Preferably, in the network, at least a subset of the electronic programme guide (EPG) data and programme data content are stored in mutually different parts of the network.

Preferably, the network nodes are configured in a manner of a peer-to-peer network.

Preferably, in the network, at least one of the network nodes and the at least one user-operable node each include a hard disc drive for storing programme data content and/or electronic programme guide (EPG) data therein.

Preferably, the network according to the second aspect of the invention is operable according to the method of the first aspect of the invention.

It will be appreciated that features of the invention are susceptible to being combined in any combination without departing from the scope of the invention.

Embodiments of the invention will now be described, by way of example only, with reference to the following diagram wherein:

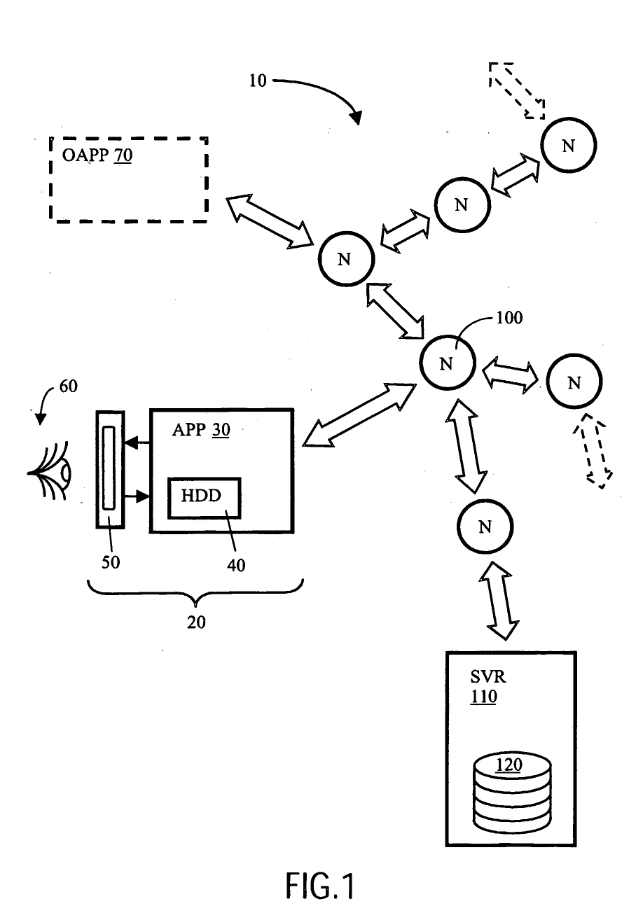

FIG. 1 is an illustration of a peer-to-peer network having stored therein programme data content in one of more Electronic Programme Guides (EPG's) and/or in associated meta-data.

In searching peer-to-peer networks, the inventors have envisaged that it is of benefit to keep Electronic Program Guide (EPG) data for a preceding period, for example 1 month back in time. By doing so, it is feasible to search peer-to-peer network periodically to determine which programme entries in EPG databases contactable on the peer-to-peer network are recorded and available to the user. Preferably, such EPG's are provided with historical indication data to distinguish data content available through the peer-to-peer network and that which is not.

Embodiments of the present invention will now be elucidated in more detail.

Peer-to-peer networks are being proposed to allow users of apparatus couplable to such networks to share data content. Such apparatus is envisaged to include hard disc drives (HDD) for storing the data content. The data content is preferably provided with Content Reference Identifiers (CRID) to ensure potentially unique identification of the content. The inventor has appreciated that although CRID uniquely identify content and so, in theory, allow content to be found in a peer-to-peer network, they do not solve the problem of finding content because such CRID's are necessarily hidden from users. Thus, users often contemporarily search for content without a clear way of identifying the content.

In overview, the present invention utilizes a characteristic that Electronic Programme Guides (EPG's) are conventionally regarded as having substantially no value after the time of transmission of their corresponding programmes and so there is superficially no reason to keep storing old EPG data. In contradistinction, the inventors have appreciated that it is beneficial to keep EPG data for a preceding period, for example 1 month. By keeping such historical records of EPG's, the aforementioned apparatus including a HDD is capable of searching a peer-to-peer network periodically to determine which EPG entries have been recorded and are available to the user of the apparatus. EPG data is then usable for distinguishing between programme data content stored locally, for example on the HDD, and programme data content available through the network.

The EPG data providing an indication of programme content and programme identification is susceptible to being stored locally on the user's apparatus and/or on a server linked to the peer-to-peer network to which the user's apparatus is coupled. Thus, the apparatus with its associated HDD and EPG data and/or access to EPG data stored remotely therefrom is capable of providing a very easy and natural way for the user to find content in the peer-to-peer network.

Referring to FIG. 1, there is shown a peer-to-peer network indicated generally by 10. The network 10 has coupled thereto a user apparatus (APP) 20 comprising a network interface 30 including a hard disc drive (HDD) 40 operable as a data store for data content. The apparatus 20 further includes an audio-visual display monitor 50 coupled thereto operable to present programme data content to a user 60 of the apparatus 20. The network 10 comprises one or more other apparatus (OAPP) denoted by 70, for example other apparatus of a similar design to the apparatus 60. The network 10 additionally includes network nodes, for example a network node 100, denoted by “N”. Moreover, the network 10 additionally comprises a data server (SVR) 110 including therein a data store 120 of considerably greater data capacity than the hard disc drive 40 of the apparatus 20. The network 10 is more extensive than illustrated in FIG. 1 and optionally includes several such servers (SVR) 110. Furthermore, the network 10 is preferably arranged to operate in a peer-to-peer manner for transferring data content therearound.

The network 10 is preferably at least one of the Internet, a wireless LAN, an optical-fibre network, a satellite communication network and a longer-distance radio communication link; the network 10 beneficially is a combination of such modes of data communication.

In operation, programme data content is susceptible to communicated around the network 10. Moreover, such content is stored in one or more of the apparatus 20, 70 and/or the server 120. The content has associated there corresponding CRID's and EPG information is also communicated around the network 10, either in association with corresponding data content or independently thereto.

The network 10 is thus a system which preferably allows the user 60 to scroll both backwards as well as forwards in time form a current date in the Electronic Programme Guides. EPG past entries corresponding to past programme content data is stored within the apparatus 20, 70 and/or on the server 110; thus, the EPG past entries are, at least in a subset of cases, indicative of programme data content available locally in the network 10. Not all past EPG entries are necessarily locally available in the network 10. When the user 60 is desirous to locate programme data content in the network 10, for example the user 60 searches through an old EPG programme entries and subsequently inputs key searching data into the apparatus 20, the apparatus 20 searches firstly to determine whether or not the content is available in the HDD 40; if the desired content is not available locally within the apparatus 20, for example by checking CRIDs of data content stored on the HDD 40, the apparatus 20 communicates the user's 60 requirements to the network 10 as a whole whose one or more other apparatus 70 and/or the server 110 check within their data stores to determine whether of not their stored data content has a CRID corresponding to the user's 60 request for data content. Where the desired programme data content is not available locally within the apparatus 20, if the apparatus 20 does not receive a response back from the network 10 within a predetermined time period, the apparatus 20 identifies therefrom that the past programme data content desired by the user 60 is not available within the network 10. Conversely, where desired programme data content is found in the network 10 remote from the apparatus 10, the network 10 is operable to convey the data content to the apparatus 20.

Thus, the EPG can optionally be used to allow the user to select entries and initiate a search through the peer-to-peer network 10 for programme data content entries and subsequently retrieve the data content. On account of EPG's containing relative good meta-data, for example CRIDs as in a TV-Anytime type system, such an approach to searching is potentially more accurate than conventional general user searches because, usually in a general user search, one does not know the location of programme data content before performing a search. Use of the EPG and associated meta-data provides an easy to use and intuitive way for the user 60 to indicate content of interest and using the associated meta-data allows very precise search queries to be formulated resulting in more accurate search results. Such a searching advantage provided by the use of past EPG data is a significant advantage of the present invention.

It will be appreciated that embodiments of the invention described in the foregoing are susceptible to being modified without departing form the scope of the invention.

Preferably, the network 10 is arranged to support periodical searching therethrough to confirm that entries in one or EPG's are still available. Such periodic searching is beneficially arranged to occur at night-time, or during periods of relatively low communication activity within the network 10, thereby assisting to try to avoid overload occurring within the network 10. One or more of the other apparatus 70 are also capable of searching through EPG's stored within the network 10 for locating corresponding programme data content in a similar manner to the apparatus 20. Advantageously, the network 10 is arranged to store locally addresses of content within the network 10 to avoid searching before downloading programme data content; optionally, the addresses of multiple locations in case content are deleted from some locations in the network 10, for example when cleaning up and/or freeing memory capacity within the network 10.

As elucidated in the foregoing, the network 10 including its apparatus 20, 70, namely collectively a system, beneficially assumes that one or more EPG's are stored locally. When the present invention is applied to a peer-to-peer network having the server 110 disposed as a centralized server, for example in a manner of a contemporary Napster-type architecture, the server 110 is capable of being used to provide easy access to most recent content; typically, recently broadcast programme data content will be most frequently accessed in the network 10.

In the foregoing, and also with regard to the accompanying claims, it will be appreciated that expressions such as “incorporate”, “contain”, “include”, “comprise”, “is” and “have” are intended to be construed non-exclusively, namely other parts or components are potentially present which have not been explicitly specified.

1. A method of searching for programme content, characterized in that the method comprises the steps of:
(a) providing a communication network (10) comprising a plurality of mutually interconnected network nodes (100, 110) susceptible to storing programme data content and at least one of electronic programme guides (EPG) and associated meta-data thereat;
(b) providing at least one user-operable node (20) coupled to the network (10), the at least one user-operable node (20) including user-interfacing means (30, 50) for receiving instructions from a user (60) and presenting results to the user (60);
(c) arranging for the plurality of network nodes (100) and/or the at least one user-operable node (20) to access electronic programme guide (EPG) data and/or associated meta-data providing a record of at least previous programme data content communicated within the network (10);
(d) presenting one or more electronic programme guides (EPG) to the user for generating therefrom a search request susceptible to utilizing meta-data associated with the one or more electronic programme guides (EPG) for use in identifying corresponding data content available in the network (10); and
(e) receiving at the at least one user-operable node (20) data content corresponding to the search request.

2. A method according to claim 1, wherein the network (10) is arranged to have stored therein electronic programme guide data (EPG) corresponding to previously communicated programme data content as well as present and future programme data content to be communicated through the network (10).

3. A method according to claim 1, wherein the user-operable node (20) augments the electronic programme guides (EPG) and/or their associated meta-data including data pertaining to past programme data content for use in determining location data indicative of whether the programme data content is available locally in the at least one user-operable node (20) or in the plurality of nodes of the network (10).

4. A method according to claim 3, wherein the presented EPG relating to previously broadcast programme data content broadcast is presented to the user, preferably in a GUI format, with an indication of which programme data content is known to be stored locally or within the network.

5. A method according to claim 1, wherein the electronic programme data (EPG) relating to previously communicated programme data content within the network (10) searched in response to the search request corresponds to programme data content communicated not more than a pre-defined period, preferably 1 month, prior to issuance of the search request from the at least one user-operable node (20).

6. A method according to claim 1, wherein the network (20) is arranged to include at least one data server (110) for providing data relating to electronic programme guides (EPG) and/or programme data content.

7. A method according to claim 1, wherein at least a subset of the electronic programme guide (EPG) data and/or its associated meta-data and/or programme data content are stored in mutually different parts of the network (10).

8. A method according to claim 1, wherein the network nodes (100) are configured in a manner of a peer-to-peer network.

9. A method according to claim 1, wherein at least one of the network nodes (110) and the at least one user-operable node (20) each include a hard disc drive (40) for storing programme data content and/or electronic programme guide (EPG) data therein.

10. A communication network (10) operable to search for programme content, characterized in that the network (10) comprises:
(a) a plurality of mutually interconnected network nodes (100, 110) susceptible to storing programme data content and at least one of electronic programme guides (EPG) and associated meta-data thereat;
(b) at least one user-operable node (20) coupled to the network (10), the at least one user-operable node (20) including user-interfacing means (30, 50) for receiving instructions from a user (60) and presenting results to the user (60), the network (10) being arranged such that:
(c) the plurality of network nodes (100) and/or the at least one user-operable node (20) are operable to access electronic programme guide (EPG) data and/or associated mete data providing a record of at least previous programme data content communicated within the network (10);
(d) the network (10) is operable to present one or more electronic programme guides (EPG) to the user (60) for generating therefrom a search request susceptible to utilizing meta-data associated with the one or more electronic programme guides (EPG) for use in identifying corresponding data content available in the network (10); and,
(e) the at least one user-operable node (20) is operable to receive data content thereat corresponding to the search request.

11. A network (10) according to claim 10, wherein the electronic programme guides (EPG) and/or their associated meta-data include data pertaining to past programme data content for use in determining location data indicative of whether the programme data content is available locally in the at least one user-operable node (20) or in the plurality of nodes of the network (10).

12. A network according to claim 10 operable according to the method of claim 1.
